(19) United States
(12) Patent Application Publication
(10) Pub. No.: US 2012/0192331 A1
(43) Pub. Date: Aug. 2, 2012

(54) METHOD FOR ADDING AN ORNAMENT TO A MANUFACTURED ARTICLE

(76) Inventors: Cynthia Fowler, Las Vegas, NV (US); William Fowler, Las Vegas, NV (US)

(21) Appl. No.: 13/358,066

(22) Filed: Jan. 25, 2012

Related U.S. Application Data
(60) Provisional application No. 61/462,020, filed on Jan. 27, 2011.
(60) Provisional application No. 61/574,194, filed on Jul. 29, 2011.

(51) Int. Cl. B23P 19/04; A45C 1/06; A43B 3/12; A43D 11/00

(52) U.S. Cl. 2/12; 29/428; 29/525.11; 12/142 S

(57) ABSTRACT

This is directed to systems, processes, machines, and other means that attach ornaments to manufactured articles. The invention can allow a user to express oneself by attaching a removable object to a manufactured article by using a screw, snap, or magnet.

### CROSS REFERENCE TO RELATED APPLICATIONS

This application claims priority to provisional patent application Nos. 61/462,020 and 61/574,194.

### FIELD OF THE INVENTION

This application relates to a method and apparatus for decorating footwear and other clothing accessories.

### BACKGROUND ART

Flip-out sandals are a product for sale that teaches a screw built into the strap. However, this product does not have center jewelry or removable female inserts. Flip-out sandals integrate the threaded female insert with the sandal strap, and do not explain how to make an entirely removable system in a comfortable manner.

SwitchFlops sandals are a product for sale that teaches a snap built into the strap. Again, this product does not have center jewelry or removable female inserts. Center jewelry provides for a larger number of combinations of ornaments that can be worn because a center article can join an unlimited number of jewelry styles to the decorated article.

### BACKGROUND OF THE INVENTION

This invention relates to interchangeable jewelry accessories (also called ornaments) that can either have an interchangeable center jewelry or that do not have an interchangeable center jewelry. The advantage over the prior art is universality, a user can choose to connect an ornament to a decorated article be a screw, snap or magnet. Only one of these needs to be purchased which is interchangeable with a large number of ornaments. Regardless of whether the jewelry has the interchangeable center, the ornament is attached to the article in the same method as described below.

### BRIEF SUMMARY OF THE INVENTION

Methods, systems, and other means are provided for adding ornaments to articles. In accordance with some embodiments, a user possesses a manufactured object and desires to add an ornament. The manufactured object comprises an attachment object, to which the user desires to attach the ornament. The user will take a first attachment mechanism which is mechanically coupled to the ornament, a joining mechanism which is separate from the ornament in some embodiments and is fixed to the ornament in other embodiments, and a second attachment mechanism which is mechanically coupled to the attachment object and connect the first attachment object with a second attachment object by using the joining mechanism. This method allows a user to mechanically couple a manufactured object and an ornament.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1: is a forward perspective view of the invention shown in use.

FIG. 2: is an exploded view of the First embodiment of the invention exemplifying the method of attachment.

FIG. 3: is an exploded view of the second embodiment of invention exemplifying the method of attachment.

FIG. 4: is an exploded view of the third embodiment of the invention exemplifying the method of attachment.

FIG. 5: is an exploded view of the fourth embodiment of the invention exemplifying the method of attachment.

FIG. 6: is a detail rear perspective of the first embodiment of the invention illustrating an exemplary jewelry article only.

FIG. 7: is a detail perspective of the first embodiment of the invention illustrating an exemplary center jewelry article only.

FIG. 8: is a detail perspective of the first embodiment of the invention illustrating the threaded female couple only.

FIG. 9: is a detail rear perspective of the second embodiment of the invention illustrating the exemplary jewelry article only.

FIG. 10: is a detail section view of the first embodiment of the invention along line 10-10 in FIG. 1.

FIG. 11: is a detail section view of the second embodiment of the invention.

FIG. 12: is a detail section view of the third embodiment of the invention.

FIG. 13: is a detail section view of the fourth embodiment of the invention.

FIG. 14: is a perspective of the fifth embodiment of the invention exemplifying the usage application concept.

FIG. 15: is a perspective of the sixth embodiment of the invention exemplifying the usage application concept.

FIG. 16: is a perspective view of the seventh embodiment of the invention exemplifying the usage application concept.

FIG. 17: is a detail rear perspective view of the third embodiment of the invention exemplifying the female snap insert only.

FIG. 18: a detail rear perspective view of the fourth embodiment of the invention exemplifying the magnet insert only.

FIG. 19: is a perspective view of the eighth embodiment of the invention.

FIG. 20: is a perspective view of the ninth embodiment of the invention.

### DETAILED DESCRIPTION OF THE INVENTION

Embodiments of the present invention overcome many of the obstacles associated with applying ornamental articles to footwear and clothing accessories, and now will be described more fully hereinafter with reference to the accompanying drawings that show some, but not all embodiments of the claimed inventions. Indeed, the invention may be embodied in many different forms and should not be construed as limited to the embodiments set forth herein. Rather, these embodiments are provided so that this disclosure will satisfy applicable legal requirements. Like numbers refer to like elements throughout.

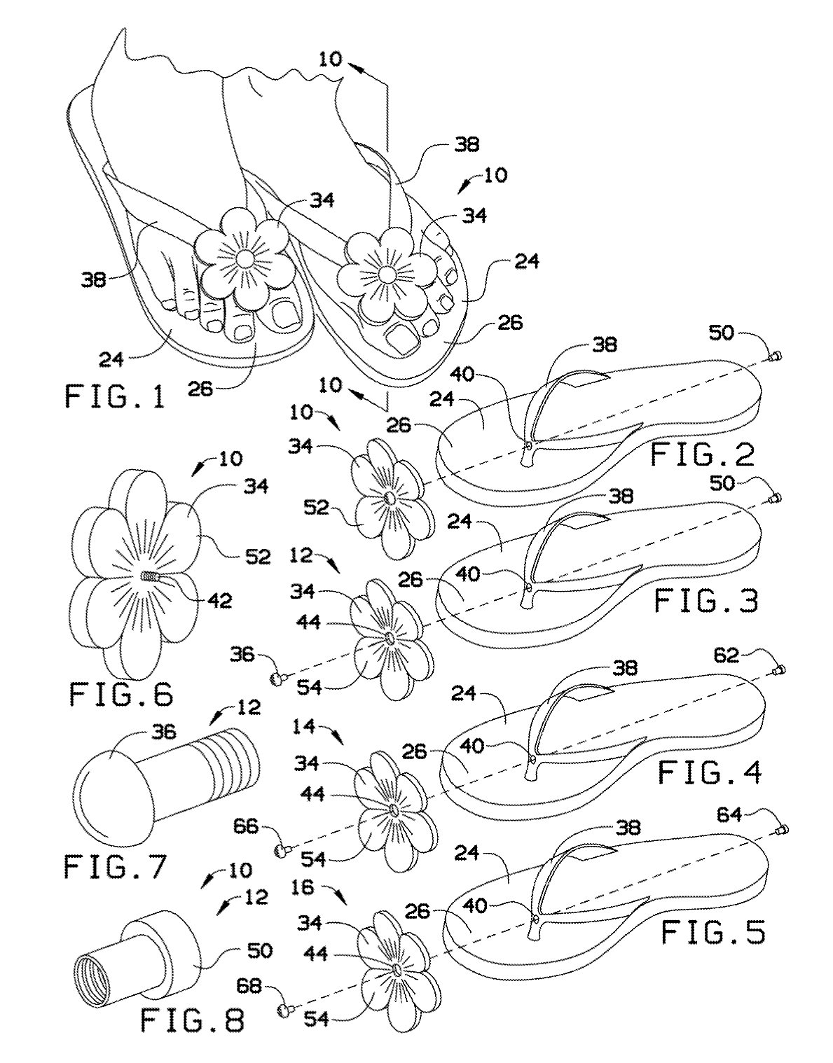

FIG. 1 shows first embodiment 10. In the first embodiment of the invention comprises footwear 24, which is well known. Footwear 24 is mechanically coupled to footwear strap 38 through attachment object 26 in a manner that is well known. Footwear strap 38 is mechanically coupled to ornament 34 in a novel manner described in FIG. 6. Footwear 24 can be a wide variety of footwear including thong slippers, fuzzy slippers and sandals.

FIG. 2 shows first embodiment 10, which comprises footwear 24 is mechanically coupled to footwear strap 38 through attachment object 26 as indicated above. Footwear strap 38 comprises hole 40 which can be made with a drill press, hole punch or other similar technique. Ornament 34 is mechanically coupled to footwear strap 38 as shown in FIG. 10 below. Threaded female coupling 50 is described in more detail in FIG. 8 below.

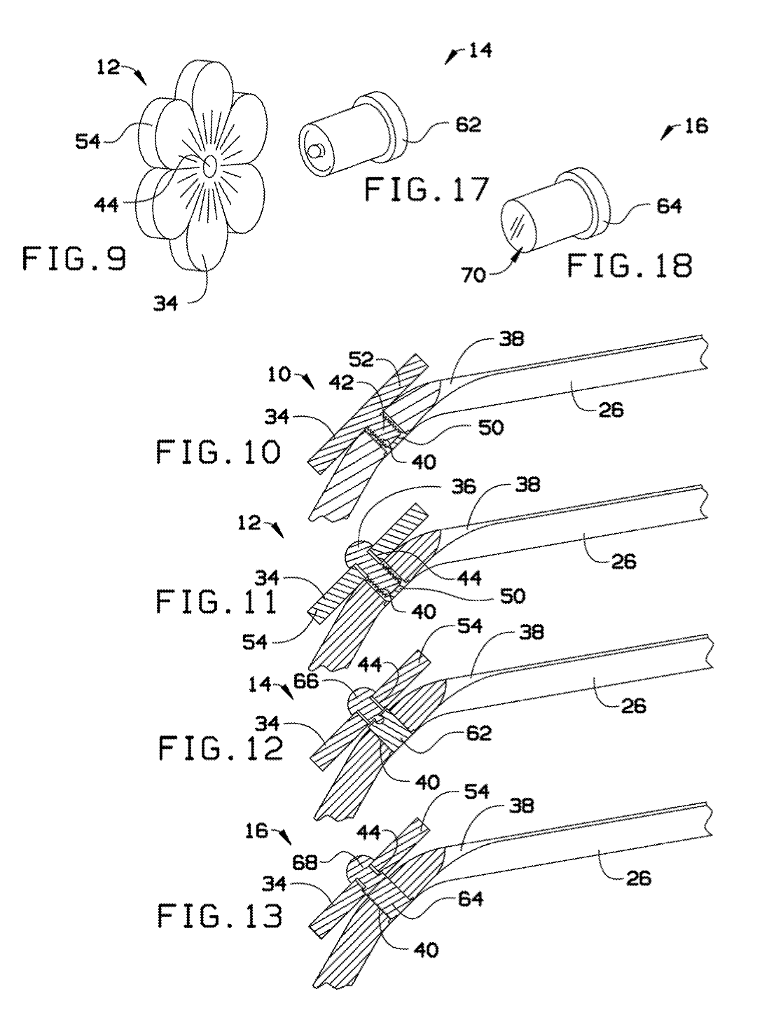

FIG. 3 shows second embodiment 12 which comprises footwear 24 is mechanically coupled to footwear strap 38 through attachment object 26 where footwear strap 38 further comprises hole 40 as indicated above. Here, ornament 34 further comprises holed ornament 54 which further comprises hole 44 which is shown in more detail in FIG. 9 below. Holed ornament 54 can be mechanically coupled to footwear strap 38 by mechanically coupling threaded female couple 50 (detailed in FIG. 8) to threaded center article 36 (detailed in FIG. 7) as shown in FIG. 11.

FIG. 4 shows third embodiment 14 which comprises footwear 24 is mechanically coupled to footwear strap 38 through attachment object 26 where footwear strap 38 further comprises hole 40 as indicated above. Here, ornament 34 further comprises holed ornament 54 which further comprises hole 44 which is shown in more detail in FIG. 9 below. Holed ornament 54 can be mechanically coupled to footwear strap 38 by mechanically coupling female snap insert 62 (detailed in FIG. 17) to snap article 66 as shown in FIG. 12. Snap insert 62 is not permanently fixed to footwear strap 38 and can be removed. Snap article 66 comprises a first end which is ornamental and wider and a second end which contains a snap and is narrow.

FIG. 5 shows fourth embodiment 16 which comprises footwear 24 is mechanically coupled to footwear strap 38 through attachment object 26 where footwear strap 38 further comprises hole 40 as indicated above. Here, ornament 34 further comprises holed ornament 54 which further comprises hole 44 which is shown in more detail in FIG. 9 below. Holed ornament 54 can be mechanically coupled to footwear strap 38 by mechanically coupling magnet insert 64 (detailed in FIG. 18) to magnet center article 68 as shown in FIG. 13. Magnet insert 64 is not permanently fixed to footwear strap 38 and can be removed. Magnet article 68 comprises a first end which is ornamental and wider and a second end which contains a magnet and is narrow.

FIG. 6 shows part of first embodiment 10 where ornament 34 comprises shafted ornament 52 which further comprises shaft 42. Shaft 42 can be threaded with conventional threading technology such that it can be mechanically coupled to threaded female coupling 50 as shown in FIG. 10.

FIG. 7 shows center article 36 which contains an ornamental portion large enough to completely cover hole 44 and a threaded portion long enough to pass through hole 44 and hole 40. The threaded portion is capable of being mechanically coupled with threaded female coupling 50 which is shown in FIG. 8.

FIG. 8 shows threaded female coupling 50 which comprises a first end which is wider than a second end such that the first end is larger than hole 40 preventing a user from pulling threaded female coupling 50 through hole 40. Threaded female coupling 50 also comprises a second end which is a threaded fastener such that threaded female coupling 50 can be mechanically coupled with center article 36.

FIG. 9 shows ornament 34 as used in second embodiment 12, third embodiment 14 and fourth embodiment 16 that comprises holed ornament 54, which further comprises hole 44. Hole 44 is sufficiently large that it can receive the second end of center article 36, the second end of snap article 66 or the second end of magnet article 68 through hole 44 in its entirety. However, it is smaller than the second end of center article 36, the second end of snap article 66 or the second end of magnet article 68 such that center article 36, snap article 66 and magnet article 68, cannot be pulled through hole 44 as shown in FIG. 11, FIG. 12 and FIG. 13.

FIG. 10 shows a section view of first embodiment 10 where attachment object 26 is mechanically coupled to footwear strap 38. Ornament 34 comprises shafted ornament 52, which further comprises shaft 42 where shaft 42 can be placed through hole 40 and mechanically coupled with footwear strap 38 by threaded female couple 50. Threaded female couple 50 is not permanently fixed to footwear strap 38 and can be removed.

In first embodiment 10, the manufactured article is footwear 24, the first attachment mechanism is shaft 42 which is mechanically coupled to shafted ornament 52, the joining mechanism is hole 40, and the second attachment mechanism is the threaded female couple 50. Here, the user could connect shafted ornament 52 to threaded female couple 50 by inserting shaft 42 into hole 40, turning shafted ornament 52 (and thus shaft 42) until the mechanical couple is complete.

FIG. 11 shows a section view of second embodiment 12 where attachment object 26 is mechanically coupled to footwear strap 38. Holed ornament 54 can be mechanically coupled to footwear strap 38 by placing center article 36 through hole 44 and into hole 40 then coupling center article 34 with threaded female couple 50.

In second embodiment 12, the manufactured article is footwear 24, the first attachment mechanism is center article 36 which is mechanically coupled to holed ornament 54, the joining mechanism is hole 44 and hole 40, and the second attachment mechanism is threaded female couple 50. Here, the user could connect holed ornament 54 to footwear strap 38 by inserting center article 36 through hole 44 and through hole 40 into threaded female couple 50 and turning center article 36 until the mechanical couple is complete. In an alternate configuration, threaded female couple 50 can be combined with hole 40 into a single item as explained above in first embodiment 10.

FIG. 12 shows a section view of third embodiment 14 where attachment object 26 is mechanically coupled to footwear strap 38. Holed ornament 54 can be mechanically coupled to footwear strap 38 by placing snap article 66 through hole 44 and into hole 40 then coupling snap article 66 with snap insert 62.

In third embodiment 14, the manufactured article is footwear 24, the first attachment mechanism is snap article 66 which is mechanically coupled to holed ornament 54, the joining mechanism is hole 44 and hole 40, and the second attachment mechanism is snap insert 62. Here, the user could connect holed ornament 54 to footwear strap 38 by inserting snap article 66 through hole 44 and through hole 40 into snap insert 62 and compressing snap article 66 until the mechanical couple is complete. In an alternate configuration, snap insert 62 can be combined with hole 40 into a single item as explained above in first embodiment 10.

FIG. 13 shows a section view of fourth embodiment 16 where attachment object 26 is mechanically coupled to footwear strap 38. Ornament 34 can be mechanically coupled to footwear strap 38 by placing magnet article 68 immediately adjacent to magnet insert 64 creating a single unit that can be removed by pulling magnet article 68 away from magnet 54.

In fourth embodiment 16, the manufactured article is footwear 24, the first attachment mechanism is magnet article 68 which is mechanically coupled to holed ornament 54, the joining mechanism is hole 44 and hole 40, and the second attachment mechanism is magnet insert 64. Here, the user could connect holed ornament 54 to footwear strap 38 by inserting magnet article 68 through hole 44 and through hole 40 into magnet insert 64 and compressing magnet article 68 until the mechanical couple is complete. In an alternate configuration, magnet insert 64 can be combined with hole 40 into a single item as explained above in first embodiment 10.

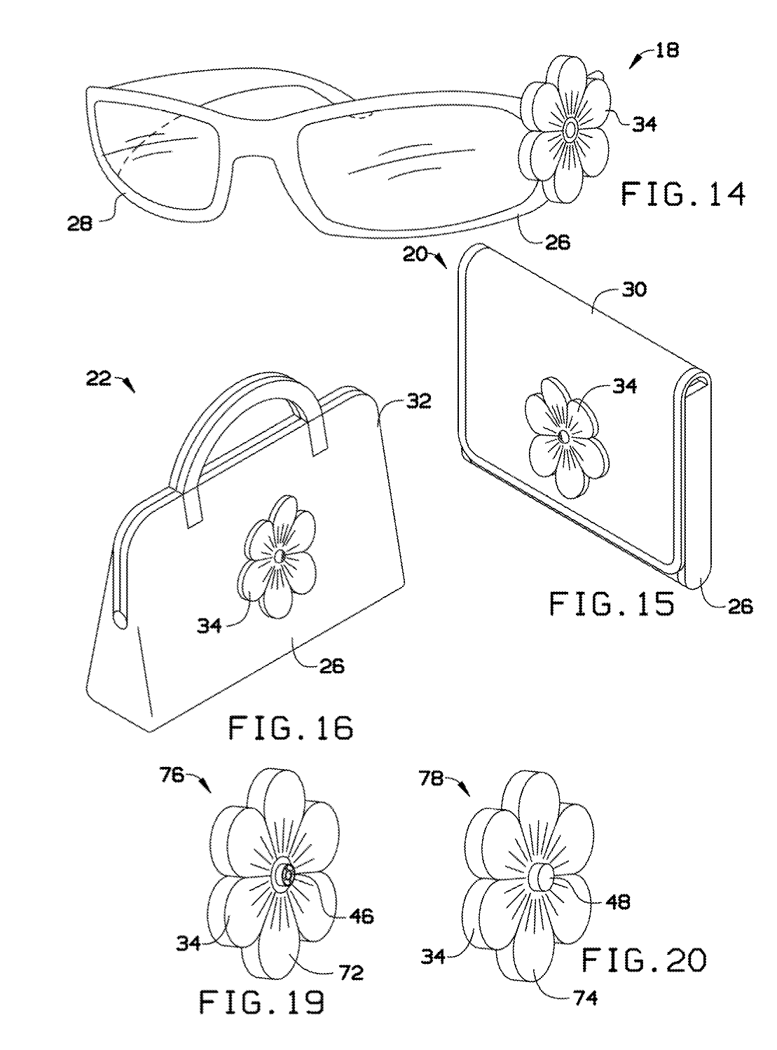

FIG. 14 shows fifth embodiment 18 which comprises glasses 28, which further comprises attachment object 26. Attachment object 26 can be mechanically coupled to ornament 34 using any of the methods outlined above. The manufactured article is glasses 28.

FIG. 15 shows sixth embodiment 20 which comprises wallet 30, which further comprises attachment object 26. Attachment object 26 can be mechanically coupled to ornament 34 using any of the methods outlined above. The manufactured article is wallet 30.

FIG. 16 shows seventh embodiment 22 which comprises purse 32, which further comprises attachment object 26. Attachment object 26 can be mechanically coupled to ornament 34 using any of the methods outlined above. The manufactured article is purse 32.

FIG. 17 shows a portion of the third embodiment 14 comprising snap insert 62. Snap insert 62 further comprises a first wide end and a second narrow end. The second narrow end is sufficiently narrow to fit through hole 40 as shown in FIG. 12. The first wide end is sufficiently large to avoid being pushed through hole 40, however it rests flush to strap 38 in a manner which is comfortable to the user.

FIG. 18 shows a portion of fourth embodiment 16 comprising magnet insert 64. Magnet insert 64 further comprises a first wide end and a second narrow end. The second narrow end is sufficiently narrow to fit through hole 40 as shown in FIG. 13. The first wide end is sufficiently large to avoid being pushed through hole 40, however it rests flush to strap 38 in a manner which is comfortable to the user.

FIG. 19 shows eighth embodiment 76 where ornament 34 comprises snap ornament 72 which further comprises snap 46. Snap 46 can be placed through hole 40 and mechanically coupled with footwear strap 38 by snap insert 62 in a manner similar to FIG. 10 above.

FIG. 20 shows ninth embodiment 78 where ornament 34 comprises magnet ornament 74 which further comprises magnet 48. Magnet 48 can be placed through hole 40 and mechanically coupled with footwear strap 38 by magnet insert 64 in a manner similar to FIG. 10 above.

That which is claimed:

1. A method for adding an ornament to a manufactured article, comprising
a manufactured article mechanically coupled to an attachment object
where the attachment object further comprises a first attachment mechanism
an ornament mechanically coupled to a second attachment mechanism
where the second attachment mechanism is mechanically coupled to the first attachment mechanism by a joining mechanism.

2. The method of claim 1, further comprising
the first attachment mechanism is a screw;
the second attachment mechanism is a hole;
the third attachment mechanism is a threaded female coupling; and
where the threaded female coupling is mechanically coupled to the hole.

3. The method of claim 1, further comprising
the first attachment mechanism is a screw;
the second attachment mechanism is a hole; and
the third attachment mechanism is a threaded female coupling.

4. The method of claim 1, further comprising
the first attachment mechanism is a snap;
the second attachment mechanism is a hole; and
the third attachment mechanism is a snap bedding.

5. The method of claim I, further comprising
the first attachment mechanism is a snap;
the second attachment mechanism is a hole; and
the third attachment mechanism is a snap bedding;
where the snap bedding is mechanically coupled to the hole.

6. The method of claim 1, further comprising
the first attachment mechanism is a first magnet;
the second attachment mechanism is a hole; and
the third attachment mechanism is a second magnet.

7. The method of claim 1, further comprising
the first attachment mechanism is a first magnet;
the second attachment mechanism is a hole; and
the third attachment mechanism is a second magnet
where the second magnet is mechanically coupled to the hole.

8. The method of claim 1 further comprising
The manufactured article is a sandal; and
The attachment article is a sandal strap

9. The method of claim 1 further comprising
The manufactured article is sunglasses; and
The attachment article is an arm.

10. The method of claim 1 further comprising
The manufactured article is a wallet; and
The attachment article is an outer covering.
